(19) United States
(12) Patent Application Publication
(10) Pub. No.: US 2018/0304353 A1
(43) Pub. Date: Oct. 25, 2018

(54) STRUCTURAL SUPPORT FOR 3D PRINTER GANTRY

(71) Applicant: Desktop Metal, Inc., Burlington, MA (US)

(72) Inventor: John LaPlante, Concord, NH (US)

(21) Appl. No.: 15/956,916

(22) Filed: Apr. 19, 2018

Related U.S. Application Data
(60) Provisional application No. 62/487,747, filed on Apr. 20, 2017.

(51) Int. Cl. B22D 23/00; B33Y 30/00; B33Y 40/00

(52) U.S. Cl. CPC B22D 23/003; B33Y 50/02; B33Y 40/00; B33Y 30/00

(57) ABSTRACT

Assemblies and support structures facilitate fabricating objects through additive manufacturing. A support structure include a column having a vertical channel extending along a surface of the column, the vertical channel being formed to couple to a motion system of a build plate. A plurality of arms extend laterally from an upper portion of the column, each of the plurality of arms having a respective rail channel aligned in a common plane. The rail channels secure respective rails of a motion system of a print head, and the plurality of arms secure the respective rails at a fixed position relative to the motion system of the build plate. A plurality of feet extending laterally from a lower portion of the column.

### RELATED APPLICATIONS

This application claims the benefit of U.S. Provisional Application No. 62/487,747, filed on Apr. 20, 2017. The entire teachings of the above application are incorporated herein by reference.

### BACKGROUND

Metal injection molding (MIM) is a metalworking process useful in creating a variety of metal objects. A mixture of powdered metal and binder (e.g., a polymer such as polypropylene) forms a “feedstock” capable of being molded, at a high temperature, into the shape of a desired object. The initial molded part, also referred to as a “green part,” then undergoes a debinding process to remove the binder, followed by a sintering process. During sintering, the part is brought to a temperature near the melting point of the powdered metal, which evaporates any remaining binder and forming the metal powder into a solid mass, thereby producing the desired object.

Additive manufacturing, also referred to as 3D printing, includes a variety of techniques for manufacturing a three-dimensional object via an automated process of forming successive layers of the object. 3D printers may utilize a feedstock comparable to that used in MIM, thereby creating a green part without the need for a mold. The green part may then undergo comparable debinding and sintering processes to produce the object.

### SUMMARY

Example embodiments include assemblies and support structures for fabricating objects through additive manufacturing. In one embodiment, an apparatus for securing a motion system of a 3D printer includes a column adapted to couple to a motion system of a build plate. A plurality of arms may extend laterally from an upper portion of the column, each of the plurality of arms having a respective coupling feature aligned in a common plane. The coupling feature may be formed to couple to a respective rail of a motion system of a print head, where the plurality of arms securing the respective rails at a fixed position relative to the motion system of the build plate. A plurality of feet may extend laterally from a lower portion of the column.

Each of the plurality of arms may include a first segment extending from the column and a second segment extending from the first segment, the second segment including the respective coupling feature. The first and second segments may extend perpendicular to one another within the common plane. The first segments may extend vertically from a junction with the column.

The respective coupling feature may include a rail channel. The rail channel may define a depression in a respective one of the plurality of arms, the depression being adapted to accommodate the respective rail within the depression. The respective coupling feature may also include at least one aperture in a respective one of the plurality of arms, the aperture being adapted to accommodate a coupling securing the respective rail to the respective arm. The respective coupling feature may include at least one raised feature extending from a respective one of the plurality of arms, the raised feature being adapted to accommodate a coupling securing the respective rail to the respective arm. the column may include at least one extension adapted to secure a shaft along which the build plate moves.

The column may include a vertical channel extending along a surface of the column, the vertical channel being formed to couple to the motion system of the build plate. The vertical channel may define a depression in the column, the depression being adapted to accommodate the respective rail within the depression. The common plane may be perpendicular to a line extending along a length of the vertical channel. The column, plurality of arms and plurality of feet may be formed of a single material extending continuously through the column, plurality of arms and plurality of feet.

Further embodiments may include a system for printing an object. A build plate assembly may include a build plate and a motion system configured to move the build plate along a vertical linear path. A print assembly may include a print head and a motion system configured to move the print head through a plane perpendicular to the vertical linear path. A support structure may include a column, a plurality of arms, and a plurality of feet. The column may be adapted to couple to the motion system of the build plate assembly. The plurality of arms may extend laterally from an upper portion of the column, each of the plurality of arms having a respective coupling feature aligned in a common plane, the coupling feature being formed to couple to a respective rail of the motion system of the print assembly, the plurality of arms securing the respective rails at a fixed position relative to the motion system of the build plate assembly. The plurality of feet may extend laterally from a lower portion of the column.

In one embodiment, an apparatus is adapted for securing a motion system of a 3D printer. The apparatus may include a column having a vertical channel extending along a surface of the column, the vertical channel being formed to couple to a motion system of a build plate. A plurality of arms may extend laterally from an upper portion of the column, each of the plurality of arms having a respective rail channel aligned in a common plane. The rail channels may be formed to couple to a respective rail of a motion system of a print head, and the plurality of arms may secure the respective rails at a fixed position relative to the motion system of the build plate. A plurality of feet extending laterally from a lower portion of the column.

Further embodiments may include a system for printing an object, comprising a build plate, a print assembly, and a support structure. The build plate assembly may include a build plate and a motion system configured to move the build plate along a vertical linear path. The print assembly including a print head and a motion system configured to move the print head through a plane perpendicular to the vertical linear path. The support structure may include a column, a plurality of arms, and a plurality of feet. The column may have a vertical channel extending along a surface of the column, the vertical channel being formed to couple to the build plate assembly. The plurality of arms may extend laterally from an upper portion of the column, each of the plurality of arms having a respective rail channel aligned in a common plane. The rail channels may be formed to couple to a respective rail of the motion system assembly, and the plurality of arms may secure the respective rails at a fixed position relative to the build plate assembly. The plurality of feet extending laterally from a lower portion of the column.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of an additive manufacturing system for use with composites.

FIGS. 2A-D illustrates a support structure that may be implemented in an additive manufacturing system.

FIGS. 3A-D illustrate a support structure including components of a 3D printer coupled to the structure.

FIG. 4 illustrates assembly of a 3D printer including a support structure, build plate assembly and printer assembly.

### DETAILED DESCRIPTION OF THE INVENTION

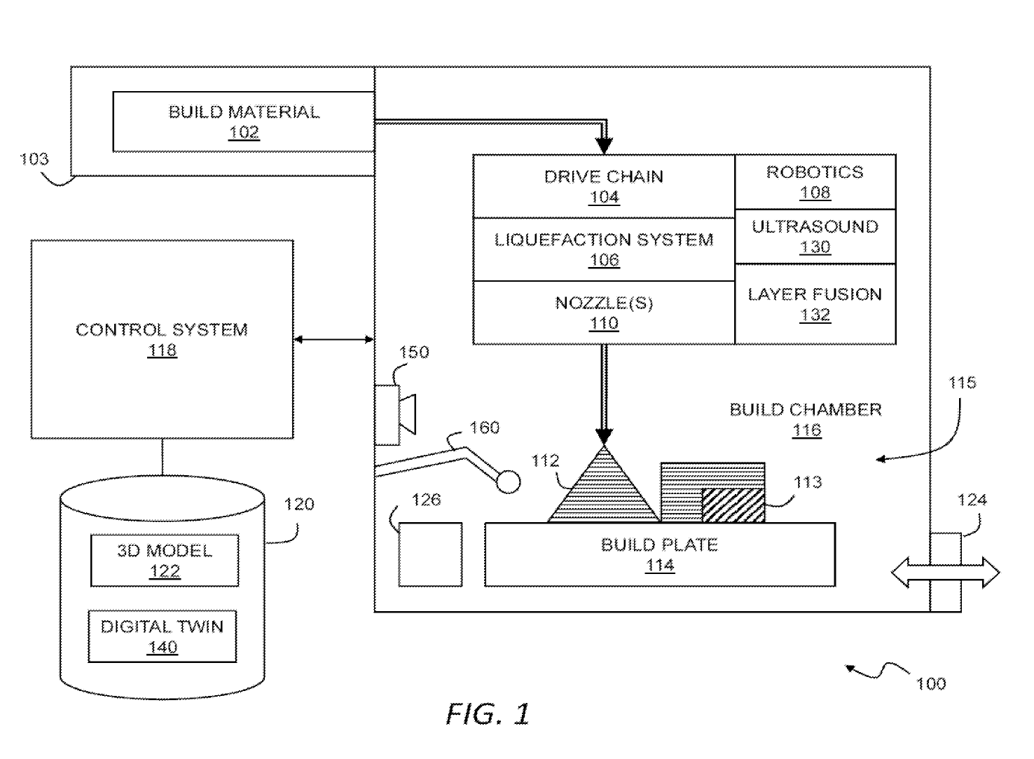

FIG. 1 is a block diagram of an additive manufacturing system for use with composites. The additive manufacturing system may include a three-dimensional printer 100 (or simply printer 100) that deposits metal using fused filament fabrication. Fused filament fabrication is well known in the art, and may be usefully employed for additive manufacturing with suitable adaptations to accommodate the forces, temperatures and other environmental requirements typical of the metallic injection molding materials described herein. In general, the printer 100 may include a build material 102 that is propelled by a drive train 104 and heated to a workable state by a liquefaction system 106, and then dispensed through one or more nozzles 110. By concurrently controlling robotic system 108 to position the nozzle(s) along an extrusion path, an object 112 may be fabricated on a build plate 114 within a build chamber 116. In general, a control system 118 manages operation of the printer 100 to fabricate the object 112 according to a three-dimensional model using a fused filament fabrication process or the like.

A variety of commercially available compositions have been engineered for metal injection molding (“MIM”). These highly engineered materials can also be adapted for use as a build material 102 in printing techniques such as fused filament fabrication. For example, MIM feedstock materials, when suitably shaped, may be usefully extruded through nozzles typical of commercially available FFF machines, and are generally flowable or extrudable within typical operating temperatures (e.g., 160-250 degrees Celsius) of such machines. This temperature range may depend on the binder—e.g., some binders achieve appropriate viscosities at about 205 degrees Celsius, while others achieve appropriate viscosities at lower temperatures such as about 160-180 C degrees Celsius. One of ordinary skill will recognize that these ranges (and all ranges listed herein) are provided by way of example and not of limitation. Further, while there are no formal limits on the dimensions for powder metallurgy materials, parts with dimensions of around 100 millimeters on each side have been demonstrated to perform well for FFF fabrication of net shape green bodies. Any smaller dimensions may be usefully employed, and larger dimensions may also be employed provided they are consistent with processing dimensions such as the print resolution and the extrusion orifice diameter. For example, implementations target about a 0.300 μm diameter extrusion, and the MIM metal powder may typically be about 1˜22 μm diameter, although nano sized powders can be used. The term metal injection molding material, as used herein, may include any such engineered materials, as well as other fine powder bases such as ceramics in a similar binder suitable for injection molding. Thus, where the term metal injection molding or the commonly used abbreviation, MIM, is used, the term may include injection molding materials using powders other than, or in addition to, metals and, thus, may include ceramics. Also, any reference to “MIM materials,” “powder metallurgy materials,” “MIM feedstocks,” or the like may generally refer to metal powder and/or ceramic powder mixed with one or more binding materials, e.g., a backbone binder that holds everything together and a bulk binder that carries the metal and backbone into position within a mold or print. Other material systems may be suitable for fabricating metal parts using fabrication techniques such as stereolithography or binder jetting, some of which are discussed in greater detail below. Such fabrication techniques may, in some applications, be identical to techniques for fabricating parts from ceramic material.

In general, fabrication of such materials may proceed as with a conventional FFF process, except that after the net shape is created, the green part may be optionally machined or finished while in a more easily workable state, and then debound and sintered into a final, dense object using any of the methods common in the art for MIM materials. The final object, as described above, may include a metal, a metal alloy, a ceramic, or another suitable combination of materials.

The build material 102 may be fed from a carrier 103 configured to dispense the build material to the three-dimensional printer either in a continuous (e.g., wire) or discrete (e.g., billet) form. The build material 102 may for example be supplied in discrete units one by one as billets or the like into an intermediate chamber for delivery into the build chamber 118 and subsequent melt and deposition. In another aspect, the carrier 103 may include a spool or cartridge containing the build material 102 in a wire form. Where a vacuum or other controlled environment is desired, the wire may be fed through a vacuum gasket into the build chamber 118 in a continuous fashion, however, typical MIM materials can be heated to a workable plastic state under normal atmospheric conditions, except perhaps for filtering or the like to remove particles from the build chamber 116. Thus in one aspect, there is described herein an apparatus including a MIM build material formed into a wire, the build material including an engineered composite of metal powder and a polymeric binder or the like, wherein the carrier 103 is configured to dispense the build material in a continuous feed to a three-dimensional printer. For environmentally sensitive materials, the carrier 103 may provide a vacuum environment for the build material 102 that can be directly or indirectly coupled to the vacuum environment of the build chamber 118. More generally, the build chamber 118 (and the carrier 103) may maintain any suitably inert environment for handling of the build material 102, such as a vacuum, and oxygen-depleted environment, an inert gas environment, or some gas or combination of gasses that are not reactive with the build material 102 where such conditions are necessary or beneficial during three-dimensional fabrication.

A drive train 104 may include any suitable gears, compression pistons, or the like for continuous or indexed feeding of the build material 116 into the liquefaction system 106. In one aspect, the drive train 104 may include gear shaped to mesh with corresponding features in the build material such as ridges, notches, or other positive or negative detents. In another aspect, the drive train 104 may use heated gears or screw mechanisms to deform and engage with the build material. Thus there is described in one aspect a printer for a fused filament fabrication process that heats a build material to a working temperature, and that heats a gear that engages with, deforms, and drives the composite in a feed path. A screw feed may also or instead be used.

For more brittle MIM materials, a fine-toothed drive gear of a material such as a hard resin or plastic may be used to grip the material without excessive cutting or stress concentrations that might otherwise crack, strip, or otherwise compromise the build material.

In another aspect, the drive train 104 may use bellows, or any other collapsible or telescoping press to drive rods, billets, or similar units of build material into the liquefaction system 106. Similarly, a piezoelectric or linear stepper drive may be used to advance a unit of build media in a non-continuous, stepped method with discrete, high-powered mechanical increments. In another aspect, the drive train 104 may include multiple stages. In a first stage, the drive train 104 may heat the composite material and form threads or other features that can supply positive gripping traction into the material. In the next stage, a gear or the like matching these features can be used to advance the build material along the feed path. A collet feed may be used (e.g., similar to those on a mechanical pencil). A soft wheel or belt drive may also or instead be used. In an aspect, a shape forming wheel drive may be used to ensure accuracy of size and thus the build. More generally, the drive train 104 may include any mechanism or combination of mechanisms used to advance build material 102 for deposition in a three-dimensional fabrication process.

The liquefaction system 106 may be any liquefaction system configured to heat the composite to a working temperature in a range suitable for extrusion in a fused filament fabrication process. Any number of heating techniques may be used. In one aspect, electrical techniques such as inductive or resistive heating may be usefully applied to liquefy the build material 102. This may, for example include inductively or resistively heating a chamber around the build material 102 to a temperature at or near the glass transition temperature of the build material 102, or some other temperature where the binder or other matrix becomes workable, extrudable, or flowable for deposition as described herein. Where the contemplated build materials are sufficiently conductive, they may be directly heated through contact methods (e.g., resistive heating with applied current) or non-contact methods (e.g., induction heating using an external electromagnet to drive eddy currents within the material). The choice of additives may further be advantageously selected to provide bulk electrical characteristics (e.g., conductance/resistivity) to improve heating. When directly heating the build material 102, it may be useful to model the shape and size of the build material 102 in order to better control electrically-induced heating. This may include estimates or actual measurements of shape, size, mass, etc.

In the above context, “liquefaction” does not require complete liquefaction. That is, the media to be used in printing may be in a multi-phase state, and/or form a paste or the like having highly viscous and/or non-Newtonian fluid properties. Thus the liquefaction system 106 described herein may include, more generally, any system that places a build material 102 in condition for use in fabrication as described herein.

In order to facilitate resistive heating of the build material 102, one or more contact pads, probes or the like may be positioned within the feed path for the material in order to provide locations for forming a circuit through the material at the appropriate location(s). In order to facilitate induction heating, one or more electromagnets may be positioned at suitable locations adjacent to the feed path and operated, e.g., by the control system 118, to heat the build material internally through the creation of eddy currents. In one aspect, both of these techniques may be used concurrently to achieve a more tightly controlled or more evenly distributed electrical heating within the build material. The printer 100 may also be instrumented to monitor the resulting heating in a variety of ways. For example, the printer 100 may monitor power delivered to the inductive or resistive circuits. The printer 100 may also or instead measure temperature of the build material 102 or surrounding environment at any number of locations. In another aspect, the temperature of the build material 102 may be inferred by measuring, e.g., the amount of force required to drive the build material 102 through a nozzle 110 or other portion of the feed path, which may be used as a proxy for the viscosity of the build material 102. More generally, any techniques suitable for measuring temperature or viscosity of the build material 102 and responsively controlling applied electrical energy may be used to control liquefaction for a fabrication process using composites as described herein.

The liquefaction system 106 may also or instead include any other heating systems suitable for applying heat to the build material 102 to a suitable temperature for extrusion. This may, for example include techniques for locally or globally augmenting heating using, e.g., chemical heating, combustion, ultrasound heating, laser heating, electron beam heating or other optical or mechanical heating techniques and so forth.

The liquefaction system 106 may include a shearing engine. The shearing engine may create shear within the composite as it is heated in order to maintain a mixture of the metallic base and a binder or other matrix, or to maintain a mixture of various materials in a paste or other build material. A variety of techniques may be employed by the shearing engine. In one aspect, the bulk media may be axially rotated as it is fed along the feed path into the liquefaction system 106. In another aspect, one or more ultrasonic transducers may be used to introduce shear within the heated material. Similarly, a screw, post, arm, or other physical element may be placed within the heated media and rotated or otherwise actuated to mix the heated material. In an aspect, bulk build material may include individual pellets, rods, or coils (e.g., of consistent size) and fed into a screw, a plunger, a rod extruder, or the like. For example, a coiled build material can be uncoiled with a heater system including a heated box, heated tube, or heater from the print head. Also, a direct feed with no heat that feeds right into the print head is also possible.

The robotic system 108 may include a robotic system configured to three-dimensionally position the nozzle 110 within the working volume 115 of the build chamber 116. This may, for example, include any robotic components or systems suitable for positioning the nozzle 110 relative to the build plate 114 while depositing the composite in a pattern to fabricate the object 112. A variety of robotics systems are known in the art and suitable for use as the robotic system 108 described herein. For example, the robotics may include a Cartesian or xy-z robotics system employing a number of linear controls to move independently in the x-axis, the y-axis, and the z-axis within the build chamber 116. Delta robots may also or instead be usefully employed, which can, if properly configured, provide significant advantages in terms of speed and stiffness, as well as offering the design convenience of fixed motors or drive elements. Other configurations such as double or triple delta robots can increase range of motion using multiple linkages. More generally, any robotics suitable for controlled positioning of the nozzle 110 relative to the build plate 114, especially within a vacuum or similar environment, may be usefully employed including any mechanism or combination of mechanisms suitable for actuation, manipulation, locomotion and the like within the build chamber 116.

The nozzle(s) 110 may include one or more nozzles for dispensing the build material 102 that has been propelled with the drive train 104 and heated with the liquefaction system 106 to a suitable working temperature. In a multiphase extrusion this may include a working temperature above the melting temperature of the metallic base of the composite, or more specifically between a first temperature at which the metallic base melts and the second temperature (above the first temperature) at which a second phase of the composite remains inert.

The nozzles 110 may, for example, be used to dispense different types of material so that, for example, one nozzle 110 dispenses a composite build material while another nozzle 110 dispenses a support material in order to support bridges, overhangs, and other structural features of the object 112 that would otherwise violate design rules for fabrication with the composite build material. In another aspect, one of the nozzles 110 may deposit a different type of material, such as a thermally compatible polymer or a metal or polymer loaded with fibers of one or more materials to increase tensile strength or otherwise improve mechanical properties of the resulting object 112. In an aspect, two types of supports may be used—(1) build supports and (2) sinter supports—e.g., using different materials printed into the same part to achieve these supports, or to create a distinguishing junction between these supports and the part.

The nozzle 110 may preferably be formed of a material or combination of materials with suitable mechanical and thermal properties. For example, the nozzle 110 will preferably not degrade at the temperatures wherein the composite material is to be dispensed, or due to the passage of metallic particles through a dispensing orifice therein. While nozzles for traditional polymer-based fused filament fabrication may be made from brass or aluminum alloys, a nozzle that dispenses metal particles may be formed of harder materials, or materials compatible with more elevated working temperatures such as a high carbon steel that is hardened and tempered. Other materials such as a refractory metal (e.g. molybdenum, tungsten) or refractory ceramic (e.g. mullite, corundum, magnesia) may also or instead be employed. In some instances, aluminum nozzles may instead be used for MIM extrusion of certain MIM materials. In another aspect, a softer thermally conductive material with a hard, wear-resistant coating may be used, such as copper with a hard nickel plating.

In one aspect, the nozzle 110 may include one or more ultrasound transducers 130 as described herein. Ultrasound may be usefully applied for a variety of purposes in this context. In one aspect, the ultrasound energy may facilitate extrusion by mitigating clogging by reducing adhesion of a build material to an interior surface of the nozzle 110. A variety of energy director techniques may be used to improve this general approach. For example, a deposited layer may include one or more ridges, which may be imposed by an exit shape of the nozzle 110, to present a focused area to receive ultrasound energy introduced into the interface between the deposited layer and an adjacent layer.

In another aspect, the nozzle 110 may include an induction heating element, resistive heating element, or similar components to directly control the temperature of the nozzle 110. This may be used to augment a more general liquefaction process along the feed path through the printer 100, e.g., to maintain a temperature of the build material 102 during fabrication, or this may be used for more specific functions, such as declogging a print head by heating the build material 102 substantially above the working range, e.g., to a temperature where the composite is liquid. While it may be difficult or impossible to control deposition in this liquid state, the heating can provide a convenient technique to reset the nozzle 110 without more severe physical intervention such as removing vacuum to disassemble, clean, and replace the affected components.

In another aspect, the nozzle 110 may include an inlet gas or fan, e.g., an inert gas, to cool media at the moment it exits the nozzle 110. The resulting gas jet may, for example, immediately stiffen the dispensed material to facilitate extended bridging, larger overhangs, or other structures that might otherwise require support structures underneath.

The object 112 may be any object suitable for fabrication using the techniques described herein. This may include functional objects such as machine parts, aesthetic objects such as sculptures, or any other type of objects, as well as combinations of objects that can be fit within the physical constraints of the build chamber 116 and build plate 114. Some structures such as large bridges and overhangs cannot be fabricated directly using fused filament fabrication or the like because there is no underlying physical surface onto which a material can be deposited. In these instances, a support structure 113 may be fabricated, preferably of a soluble or otherwise readily removable material, in order to support the corresponding feature.

Where multiple nozzles 110 are provided, a second nozzle may usefully provide any of a variety of additional build materials. This may, for example, include other composites, alloys, bulk metallic glass's, thermally matched polymers and so forth to support fabrication of suitable support structures. In one aspect, one of the nozzles 110 may dispense a bulk metallic glass that is deposited at one temperature to fabricate a support structure 113, and a second, higher temperature at an interface to a printed object 112 where the bulk metallic glass can be crystallized at the interface to become more brittle and facilitate mechanical removal of the support structure 113 from the object 112. Conveniently, the bulk form of the support structure 113 can be left in the super-cooled state so that it can retain its bulk structure and be removed in a single piece. Thus in one aspect there is described herein a printer that fabricates a portion of a support structure 113 with a bulk metallic glass in a super-cooled liquid region, and fabricates a layer of the support structure adjacent to a printed object at a greater temperature in order to crystallize the build material 102 into a non-amorphous alloy. The bulk metallic glass particles may thus be loaded into a MIM feedstock binder system and may provide a support. Pure binding or polymer materials (e.g., without any loading) may also or instead provide a support. A similar metal MIM feedstock may be used for multi-material part creation. Ceramic or dissimilar metal MIM feedstock may be used for a support interface material.

### Support Materials

In general, the MIM media includes a binder and a metal powder (or other material as described herein, such as ceramic powder). A support material may also be provided from a second nozzle consisting of, e.g., the binder used for the injection molding material, without the structural material that sinters into the final object. In another aspect, the support material may be formed of a wax, or some other thermoplastic or other polymer that can be removed during processing of a printed green body. This support material may, for example, be used for vertical supports, as well as for top or side supports, or any other suitable support structures to provide a physical support during printing and subsequent sintering. Printing and sintering may impose different support requirements. As such, different support materials and or different support rules may be employed for each type of required support. Additionally, the print supports may be removed after a print and before sintering, while sintering supports would be left attached to the green object until sintering is completed (or sufficiently completed to eliminate the need for the sintering support structures).

In another aspect, the second nozzle (or a third nozzle) may be used to provide an interface material that is different from the support material, such as the corresponding binder, along with a ceramic or some other material that will not sinter under the time and temperature conditions used to sinter the injection molding material. This may also or instead include a metal or the like that forms a brittle interface with the sintered part so that it can break away from the final object easily after sintering. Where this interface material does not sinter, it may be used in combination with a sinterable support structure that can continue to provide structural support during a sintering process.

The support material(s) may usefully integrate other functional substances. For example, titanium may be added to the support material as an oxygen getter to improve the build environment without introducing any titanium into the fabricated object. Other types of additives may also or instead be used to remove contaminants. For example, a zirconium powder (or other strong carbide former) may be added to the support material in order to extract carbon contamination during sintering.

### Nested Parts

In one aspect, the use of non-structural support at the interface, e.g. a pure binder that does not sinter into a structural object, may be used to facilitate the additive manufacture of nested parts. For example, a complete gear box or the like may be fabricated within an enclosure, with the surfaces between gear teeth fabricated with a non-sintering binder or other material. In one aspect, critical mechanical interfaces for such mechanical parts may be oriented to the fabrication process, e.g., by orienting mating surfaces vertically so that smaller resolutions can be used. More generally, the capability to print adjacent, non-coupled parts may be used to fabricate multiple physically related parts in a single print job. This may, for example, include hinges, gears, captive bearings or other nested or interrelated parts. Non-sintering support material may be extracted, e.g., using an ultrasonicator, fluid cleaning, or other techniques after the object is sintered to a final form. In an aspect, the binder is loaded with a non-sintering additive such as ceramic or dissimilar, higher sintering temp metal.

This general approach may also affect the design of the part. For example, axles may employ various anti-backlash techniques so that the sintered part is more securely retained during movement and use. Similarly, fluid paths may be provided for fluid cleaning, and removal paths may be created for interior support structures. This technique may also be used to address other printing challenges. For example, support structures within partially enclosed spaces may be fabricated for removal through some removal path after the object is completed. If the support structures are weakly connected, or unconnected, to the fabricated object, they can be physically manipulated for extraction through the removal path. In an aspect, parts may be “glued” together with an appropriate (e.g., the same) MIM material to make larger parts that essentially have no joints once sintered.

The build plate 114 within the working volume 115 of the build chamber 116 may include a rigid and substantially planar surface formed of any substance suitable for receiving deposited composite or other material(s)s from the nozzles 110. In one aspect, the build plate 114 may be heated, e.g., resistively or inductively, to control a temperature of the build chamber 116 or the surface upon which the object 112 is being fabricated. This may, for example, improve adhesion, prevent thermally induced deformation or failure, and facilitate relaxation of stresses within the fabricated object. In another aspect, the build plate 114 may be a deformable build plate that can bend or otherwise physical deform in order to detach from the rigid object 112 formed thereon.

The build chamber 116 may be any chamber suitable for containing the build plate 114, an object 112, and any other components of the printer 100 used within the build chamber 116 to fabricate the object 112. In one aspect, the build chamber 116 may be an environmentally sealed chamber that can be evacuated with a vacuum pump 124 or similar device in order to provide a vacuum environment for fabrication. This may be particularly useful where oxygen causes a passivation layer that might weaken layer-to-layer bonds in a fused filament fabrication process as described herein, or where particles in the atmosphere might otherwise interfere with the integrity of a fabricated object, or where the build chamber 116 is the same as the sintering chamber. In another aspect, only oxygen is removed from the build chamber 116.

Similarly, one or more passive or active oxygen getters 126 or other similar oxygen absorbing material or system may usefully be employed within the build chamber 116 to take up free oxygen within the build chamber 116. The oxygen getter 126 may, for example, include a deposit of a reactive material coating an inside surface of the build chamber 116 or a separate object placed therein that completes and maintains the vacuum by combining with or adsorbing residual gas molecules. The oxygen getters 126, or more generally, gas getters, may be deposited as a support material using one of the nozzles 110, which facilitates replacement of the gas getter with each new fabrication run and can advantageously position the gas getter(s) near printed media in order to more locally remove passivating gasses where new material is being deposited onto the fabricated object. In one aspect, the oxygen getters 126 may include any of a variety of materials that preferentially react with oxygen including, e.g., materials based on titanium, aluminum, and so forth. In another aspect, the oxygen getters 126 may include a chemical energy source such as a combustible gas, gas torch, catalytic heater, Bunsen burner, or other chemical and/or combustion source that reacts to extract oxygen from the environment. There are a variety of low-CO and NOx catalytic burners that may be suitably employed for this purpose without CO.

In one aspect, the oxygen getter 126 may be deposited as a separate material during a build process. Thus in one aspect there is described herein a process for fabricating a three-dimensional object from a metallic composite including co-fabricating a physically adjacent structure (which may or may not directly contact the three-dimensional object) containing an agent to remove passivating gasses around the three-dimensional object. Other techniques may be similarly employed to control reactivity of the environment within the build chamber 116, or within post-processing chambers or the like as described below. For example, the build chamber 116 may be filled with an inert gas or the like to prevent oxidation.

The control system 118 may include a processor and memory, as well as any other co-processors, signal processors, inputs and outputs, digital-to-analog or analog-to-digital converters and other processing circuitry useful for monitoring and controlling a fabrication process executing on the printer 100. The control system 118 may be coupled in a communicating relationship with a supply of the build material 102, the drive train 104, the liquefaction system 106, the nozzles 110, the build plate 114, the robotic system 108, and any other instrumentation or control components associated with the build process such as temperature sensors, pressure sensors, oxygen sensors, vacuum pumps, and so forth. The control system 118 may be operable to control the robotic system 108, the liquefaction system 106 and other components to fabricate an object 112 from the build material 102 in three dimensions within the working volume 115 of the build chamber 116.

The control system 118 may generate machine ready code for execution by the printer 100 to fabricate the object 112 from the three-dimensional model 122. The control system 118 may deploy a number of strategies to improve the resulting physical object structurally or aesthetically. For example, the control system 118 may use plowing, ironing, planing, or similar techniques where the nozzle 110 runs over existing layers of deposited material, e.g., to level the material, remove passivation layers, apply an energy director topography of peaks or ridges to improve layer-to-layer bonding, or otherwise prepare the current layer for a next layer of material. The nozzle 110 may include a low-friction or non-stick surface such as Teflon, TiN or the like to facilitate this plowing process, and the nozzle 110 may be heated and/or vibrated (e.g., using an ultrasound transducer) to improve the smoothing effect. In one aspect, this surface preparation may be incorporated into the initially-generated machine ready code. In another aspect, the printer 100 may dynamically monitor deposited layers and determine, on a layer-bylayer basis, whether additional surface preparation is necessary or helpful for successful completion of the object.

In one aspect, the control system 118 may employ pressure or flow rate as a process feedback signal. While temperature is frequently the critical physical quantity for fabrication with thermoplastic binders, it may be difficult to accurately measure the temperature of a composite build material throughout the feed path. However, the temperature can be inferred by the viscosity of the build material, which can be estimated for the bulk material based on how much force is being applied to drive the material through a feed path. Thus in one aspect, there is described herein a printer that measures the force applied by a drive train to a composite such as any of the composites described above, infers a temperature of the build material based on the instantaneous force, and controls a liquefaction system to adjust the temperature accordingly.

In general, a three-dimensional model 122 of the object may be stored in a database 120 such as a local memory of a computer used as the control system 118, or a remote database accessible through a server or other remote resource, or in any other computer-readable medium accessible to the control system 118. The control system 118 may retrieve a particular three-dimensional model 122 in response to user input, and generate machine-ready instructions for execution by the printer 100 to fabricate the corresponding object 112. This may include the creation of intermediate models, such as where a CAD model is converted into an STL model or other polygonal mesh or other intermediate representation, which can in turn be processed to generate machine instructions for fabrication of the object 112 by the printer 100.

In another aspect, the nozzle 110 may include one or more mechanisms to flatten a layer of deposited material and apply pressure to bond the layer to an underlying layer. For example, a heated nip roller, caster, or the like may follow the nozzle 110 in its path through an x-y plane of the build chamber to flatten the deposited (and still pliable) layer. The nozzle 110 may also or instead integrate a forming wall, planar surface or the like to additionally shape or constrain a build material 102 as it is deposited by the nozzle 110. The nozzle 110 may usefully be coated with a non-stick material (which may vary according to the build material being used) in order to facilitate more consistent shaping and smoothing by this tool.

In another aspect, a layer fusion system 132 may be used to encourage good mechanical bonding between adjacent layers of deposited build material within the object 112. This may include the ultrasound transducers described above, which may be used to facilitate bonding between layers by applying ultrasound energy to an interface between layers during deposition. In another aspect, current may be passed through an interface between adjacent layers in order to Joule heat the interface and liquefy or soften the materials for improved bonding. Thus in one aspect, the layer fusion system 132 may include a joule heating system configured to apply a current between a first layer of the build material and a second layer of the build material in the working volume 115 while the first layer is being deposited on the second layer. In another aspect, the layer fusion system 132 may include an ultrasound system for applying ultrasound energy to a first layer of the build material while the first layer is being deposited onto a second layer of the build material in the working volume 115. In another aspect, the layer fusion system 132 may include a rake, ridge(s), notch(es) or the like formed into the end of the nozzle 110, or a fixture or the like adjacent to the nozzle, in order to form energy directors on a top surface of a deposited material. Other techniques may also or instead be used to improve layer-to-layer bonding, such as plasma cleaning or other depassivation before or during formation of the interlayer bond. The use of injection molding materials can alleviate many of the difficulties of forming layer-to-layer bonds with deposited metals, but these and other techniques may nonetheless be useful in improving interlayer bonds and/or shaping a fabricated object as described herein.

During fabrication, detailed data may be gathered for subsequent use and analysis. This may, for example, include a camera and computer vision system that identifies errors, variations, or the like that occur in each layer of an object. Similarly, tomography or other imaging techniques may be used to detect and measure layer-to-layer interfaces, aggregate part dimensions, diagnostic information (e.g., defects, voids) and so forth. This data may be gathered and delivered with the object to an end user as a digital twin 140 of the object 112 so that the end user can evaluate whether and how variations and defects might affect use of the object 112. In addition to spatial/geometric analysis, the digital twin 140 may log process parameters including, for example, aggregate statistics such as weight of material used, time of print, variance of build chamber temperature, and so forth, as well as chronological logs of any process parameters of interest such as volumetric deposition rate, material temperature, environment temperature, and so forth.

The printer 100 may include a camera 150 or other optical device. In one aspect, the camera 150 may be used to create the digital twin 140 described above, or to more generally facilitate machine vision functions or facilitate remote monitoring of a fabrication process. Video or still images from the camera 150 may also or instead be used to dynamically correct a print process, or to visualize where and how automated or manual adjustments should be made, e.g., where an actual printer output is deviating from an expected output.

The printer 100 may also usefully integrate a subtractive fabrication tool 160 such as a drill, milling bit, or other multi-axis controllable tool for removing material from the object 112 that deviates from an expected physical output based on the 3D model 122 used to fabricate the object 112. While combinations of additive and subtractive technologies have been described, the use of MIM materials provides a unique advantage when subtractive shaping is performed on a green object after net shape forming but before sintering (or debinding), when the object 112 is relatively soft and workable. This permits quick and easy removal of physically observable defects and printing artifacts before the object 112 is sintered into a metal object. An aspect may instead include tapping threads or otherwise adding features as opposed to subtracting parts. Similarly, an aspect may include combining multiple single green parts into one larger fully solid sintered part.

Other useful features may be integrated into the printer 100 described above. For example, a solvent or other material may be usefully applied a surface of the object 112 during fabrication to modify its properties. This may, for example intentionally oxidize or otherwise modify the surface at a particular location or over a particular area in order to provide a desired electrical, thermal optical, or mechanical property. This capability may be used to provide aesthetic features such as text or graphics, or to provide functional features such as a window for admitting RF signals.

### Design Rules

In general, a fabrication process such as fused filament fabrication implies, or expressly includes, a set of design rules to accommodate physical limitations of a fabrication device and a build material. For example, a horizontal shelf cannot be fabricated without positioning a support structure underneath. While the design rules for FFF may apply to fabrication of a green body using FFF techniques as described herein, the green body may also be subject to various MIM design rules. This may, for example, include a structure to prevent or minimize drag on a floor while a part shrinks during sintering which may be 20% or more depending on the composition of the green body. Similarly, certain supports are required during sintering that are different than the supports required during fused filament fabrication. As another example, injection molding typically aims for uniform wall thickness to reduce variability in debinding and/or sintering behaviors, with thinner walls being preferred. The system described herein may apply to disparate sets of design rules—those for the rapid prototyping system (e.g., fused filament fabrication) and those for the sintering process (e.g., MIM design rules)—to a CAD model that is being prepared for fabrication.

These rules may also be combined under certain conditions. For example, the support structures for a horizontal shelf during fabrication must resist the force of an extrusion/deposition process used to fabricate the horizontal shelf, whereas the support structure during sintering only needs to resist the forces of gravity during the baking process. Thus there may be two separate supports that are removed at different times during a fabrication process: the fabrication supports that are configured to resist the force of a fabrication process and may be breakaway supports that are loosely mechanically coupled to a green body, along with sintering supports that may be less extensive, and only need to resist the gravitation forces on a body during sintering. These latter supports are preferably coupled to the object through a nonsinterable layer to permit easy removal from the densified final object. In another aspect, the fabrication supports may be fabricated from binder without a powder or other fill so that they completely disappear during a sintering process.

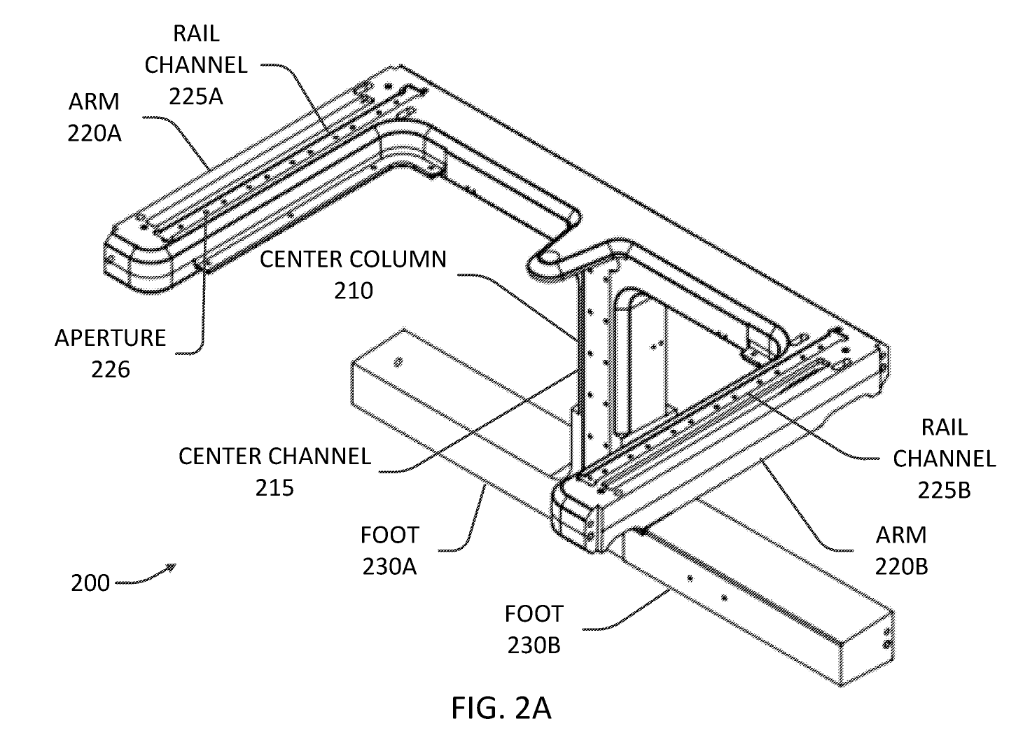

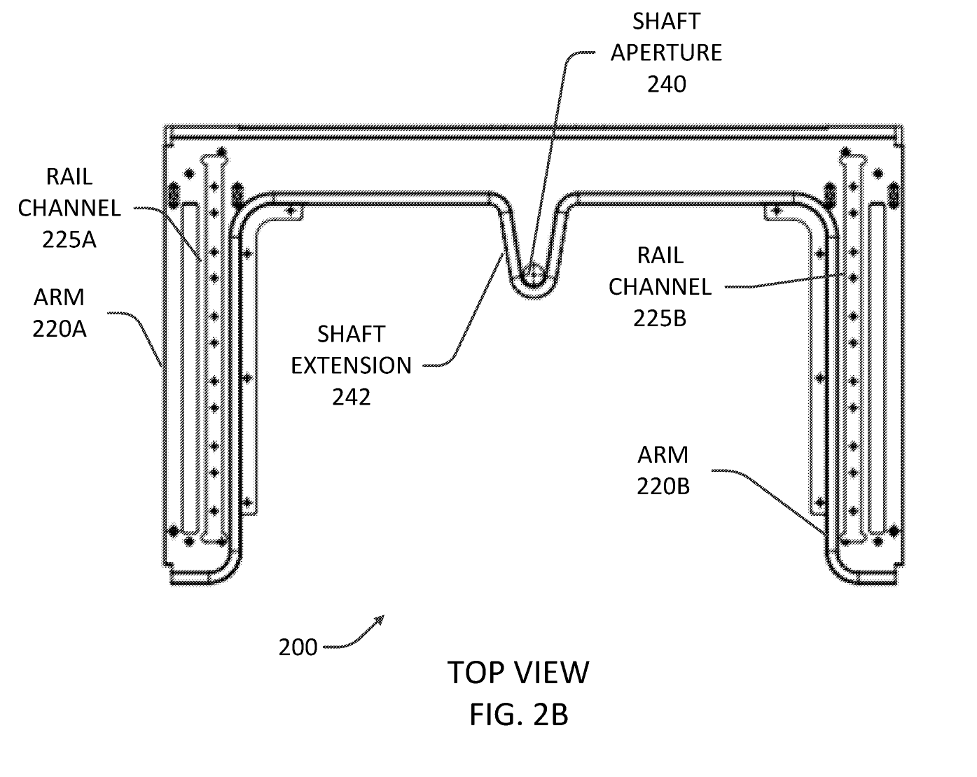

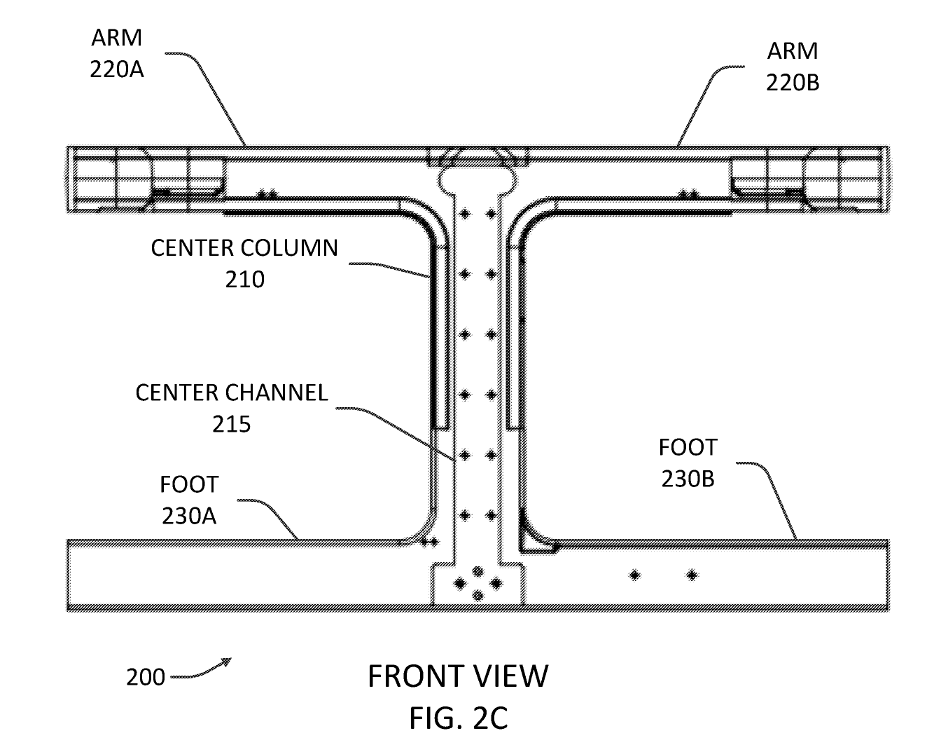

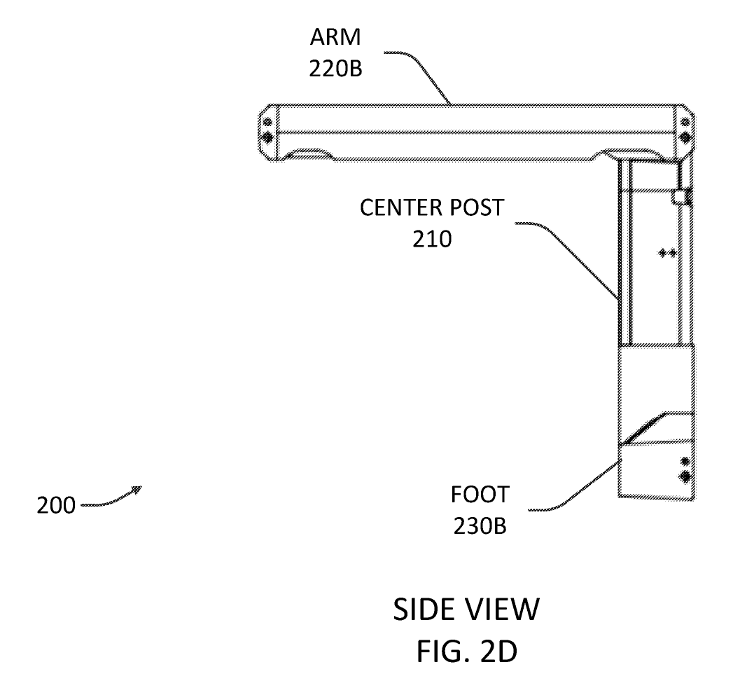

FIGS. 2A-D illustrates a support structure 200 that may be implemented in an additive manufacturing system. The support structure 200 may be implemented in a 3D printer such as the printer 100 described above. In particular, the structure 200 may be configured to support the printer assembly (including the print head (e.g., 104, 106, 110) and motion system (e.g., robotics 108), as well as support the build plate 114 and a motion system controlling positioning of the build plate 114.

As shown in the isometric view of FIG. 2A, the support structure 200 includes a center column 210 having a center channel 215 extending along a surface of the column 210. Arms 220A-B extend laterally and outward from an upper portion of the column 210, and each include a 90-degree bend such that an outer portion of each arm 220A-B is aligned parallel to one another. Each of the plurality of arms 220A-B may form a respective rail channel 225A-B. The rail channels 225A-B may be aligned in a common plane. Further, a plurality of feet 230A-B extend laterally from a lower portion of the column 210. FIGS. 2B, 2C and 2D illustrate top, front and side views, respectively, of the support structure 200. In further embodiments, the plurality of arms 220A-B and/or feet 230A-B may also extend vertically from the column 210 in addition to laterally, thereby forming a diagonal or sloped extension from the column 210.

The support structure 200 may be implemented to support and secure a fixed location to several components of a 3D printer. For example, the center channel 215 may be formed to be couple to a motion system of a build plate. Further, as shown in FIG. 2B, the center column 210 may also extend, via a shaft extension 242, to form a shaft aperture 240, which may be implemented in conjunction with the center channel 215 to secure the motion system of the build plate. The rail channels 225A-B may be formed to be coupled to a respective rail of a motion system of a print head, and the arms 220A-B may secure the respective rails 225A-B at a fixed position relative to the motion system of the build plate. The rail channels 225A-B and center channel 215 may each form a respective depression within the arms 220A-B and center column 210, where the depressions are shaped to accommodate features of the respective rails to which they are coupled, thereby securing the rails. Additional apertures within the channels 225A-B, 215 (e.g., aperture 226), such as screw holes or rivet holes, may be aligned to accommodate screws, bolts, rivets or other tools to secure the respective rails to the channels 225A-B, 215. Alternatively, the arms 220A-B and center column 210 may include coupling features or other means for securing the respective rails in place of the channels 225A-B, 215. For example, the channels 225A-B, 215 may form one or more raised features, such as cylinders or tracks, that align with mating features of the respective rails. Thus, the arms 220A-B and column 210 may form a mating surface with or without depressions or raised features, and may rely on apertures as described above to secure the respective rails.

The support structure 200 may be formed of a single piece of material. For example, the structure 200 may be machined from a single block of metal (e.g., aluminum), or may be formed via casting. Such a manufacture enables the structure 200 to provide rigid support to the components coupled to it, and secures those components in a fixed spatial relationship to one another. For example, the rail channels 225A-B may secure a motion system of a print head to a first plane (i.e., a plane occupying the rail channels 225A-B), and the center channel 215 may secure the motion system of a build plate to a second plane (i.e., a plane aligned with the center channel 215), where the first plane is perpendicular to the second plane. In such an application, the motion system of the print head may move the print head within a plane parallel to the first plane (e.g., X/Y motion), while the motion system of the build plate moves the build plate vertically and perpendicular to the first plane (e.g., Z motion). Such an alignment of the motion systems, secured by the support structure 200, enables the printer to move the print head relative to the build plate in three dimensions accurately and precisely.

The structure 200 may also be formed with sufficient mass (e.g., a solid material) so as to minimize transmission of vibrations caused by the motion systems. Alternatively, portions of the structure 200 may be formed with cavities, particularly if the resulting structure possesses sufficient strength and rigidity for the given application.

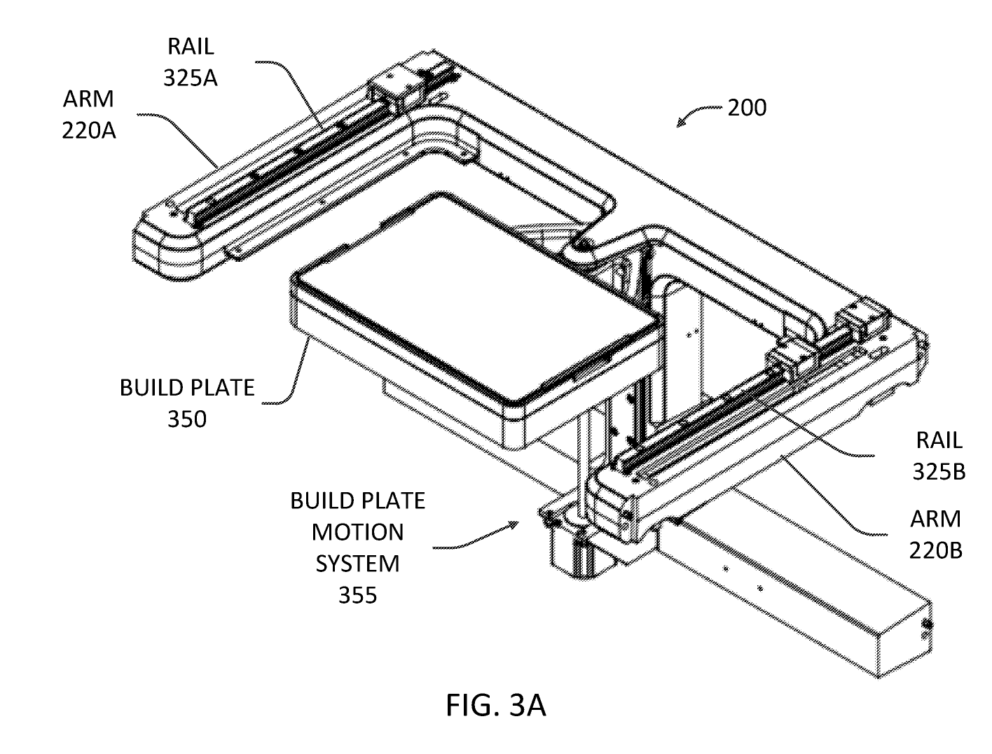

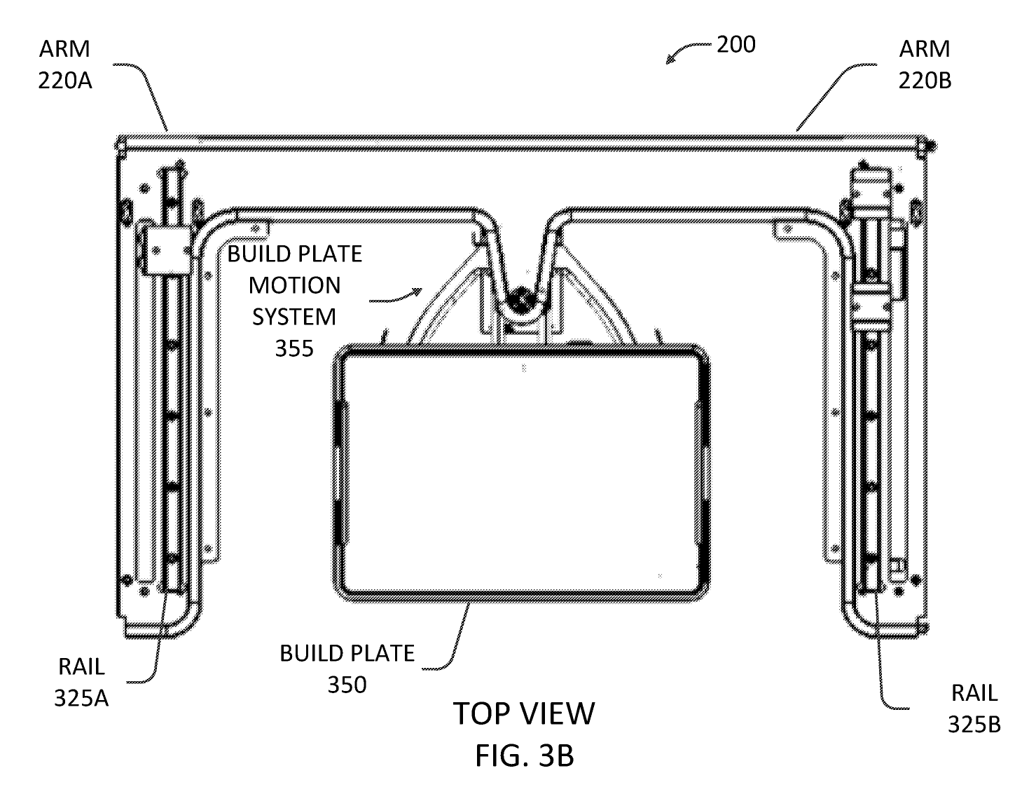

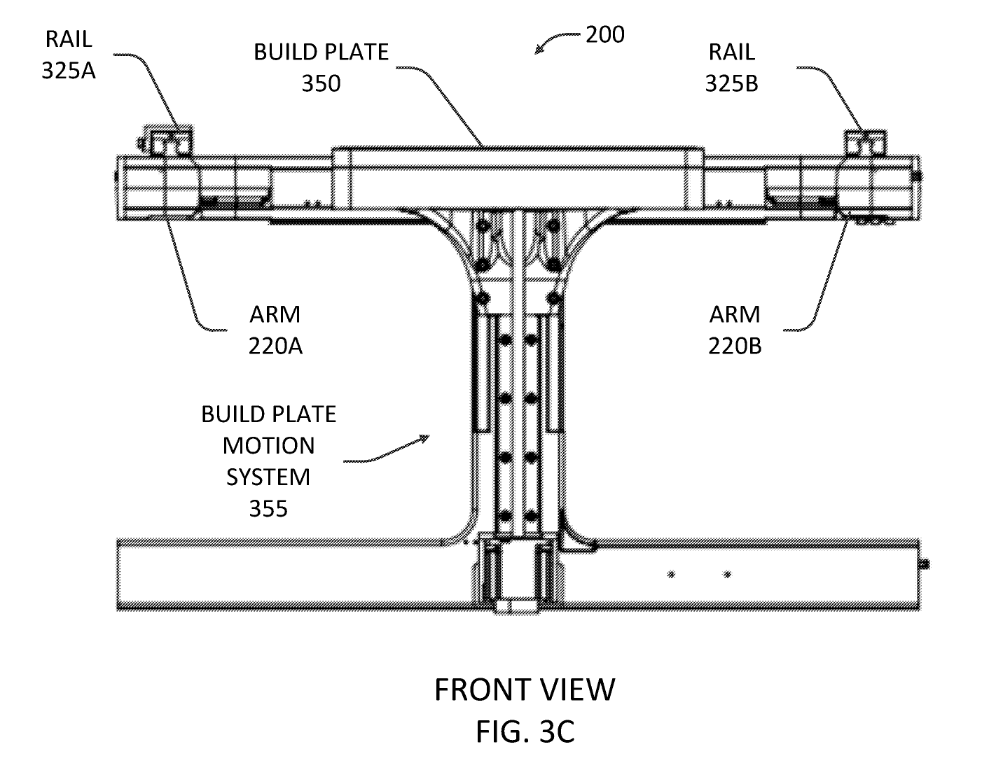

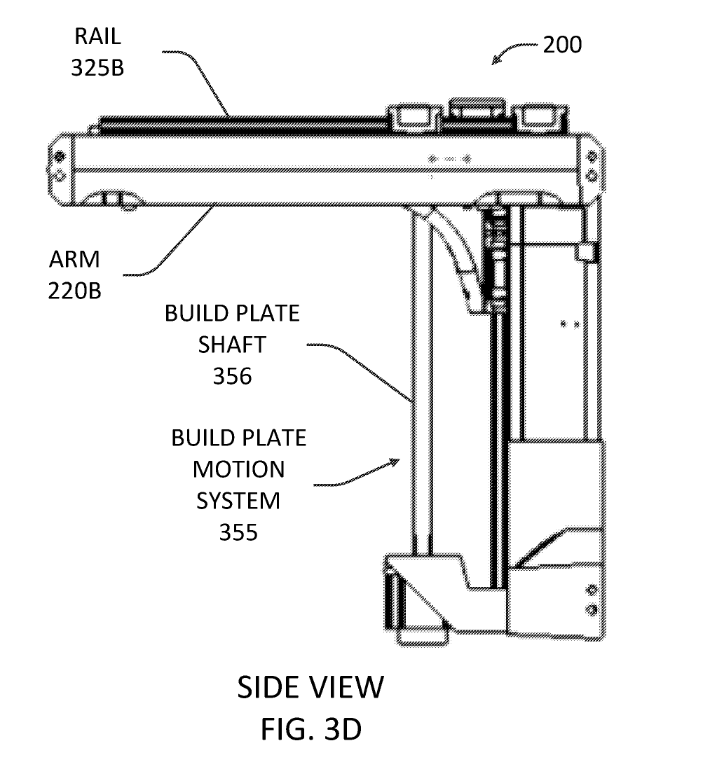

FIGS. 3A-D illustrate the support structure 200 including components of a 3D printer coupled to the structure 200. In particular, rails 325A-B may be coupled to respective channels 225A-B of the arms 220A-B, and a build plate motion system 355 may be coupled to the center channel 215. The build plate motion system 355 may, in turn, be coupled to a build plate 350, and include components (e.g., a motor, a shaft 356 and a shaft link) to move the build plate 350 vertically, where the build plate 350 may be moved along the shaft 356. Likewise, the rails 325A-B may accommodate a motion system of a print head, enabling the print head to move within a horizontal plane parallel to the plane defined by the rail channels 225A-B.

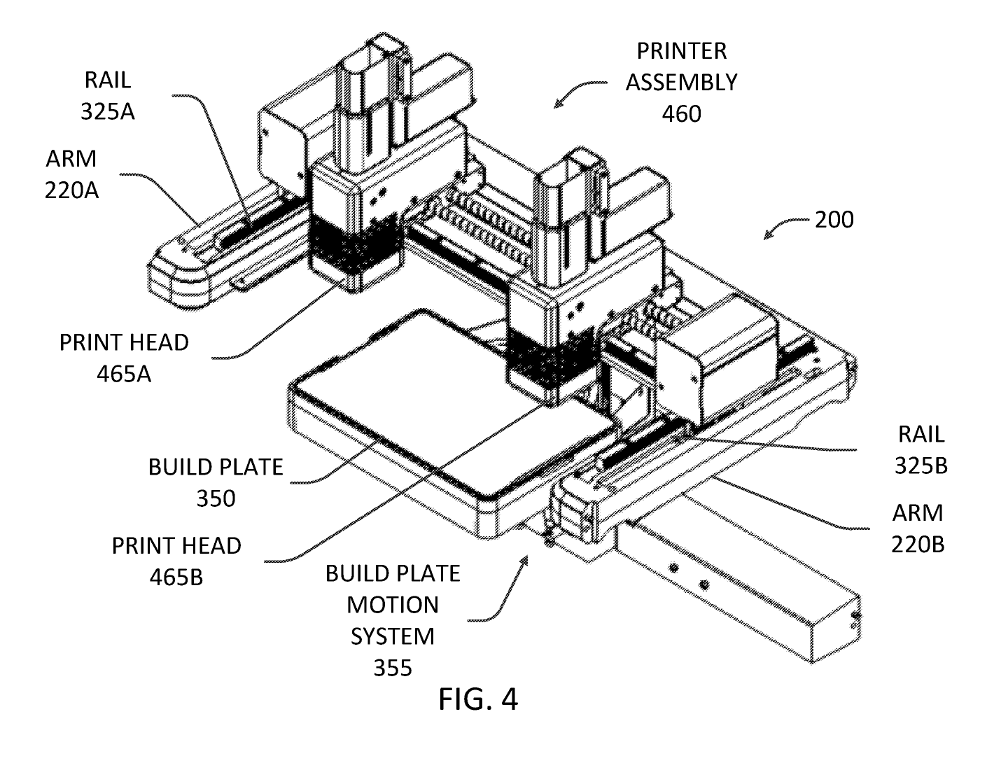

FIG. 4 illustrates assembly of a 3D printer including the support structure 460, a build plate assembly (e.g., build plate 350 and motion system 355), and a printer assembly 460. In addition to the components described above, the printer assembly 460 may be moveably coupled to the rails 325A-B, and includes a motion system to move print heads 465A-B through a horizontal plane. The rail channels 225A-B secure the motion of the printer assembly to a first, horizontal plane, and the center channel 215 may secure the build plate motion system 355 to enable the motion system 355 to move the build plate 350 in a linear direction perpendicular to the horizontal plane. As a result of securement to the support structure 200, the printer assembly 460 may move the print heads 465A-B within a plane parallel to the first plane (e.g., X/Y motion), while the build plate motion system 355 moves the build plate 355 vertically and perpendicular to the first plane (e.g., Z motion). Thus, the support structure 200 enables the printer to move the print heads 465A-B relative to the build plate 350 in three dimensions accurately and precisely.

While this invention has been particularly shown and described with references to example embodiments thereof, it will be understood by those skilled in the art that various changes in form and details may be made therein without departing from the scope of the invention encompassed by the appended claims.

What is claimed is:

1. An apparatus for securing a motion system of a 3D printer, comprising:
a column adapted to couple to a motion system of a build plate;
a plurality of arms extending laterally from an upper portion of the column, each of the plurality of arms having a respective coupling feature aligned in a common plane, the coupling feature being formed to couple to a respective rail of a motion system of a print head, the plurality of arms securing the respective rails at a fixed position relative to the motion system of the build plate; and
a plurality of feet extending laterally from a lower portion of the column.

2. The apparatus of claim 1, wherein each of the plurality of arms includes a first segment extending from the column and a second segment extending from the first segment, the second segment including the respective coupling feature.

3. The apparatus of claim 2, wherein the first and second segments extend perpendicular to one another within the common plane.

4. The apparatus of claim 2, wherein the first segments extend vertically from a junction with the column.

5. The apparatus of claim 1, where in the respective coupling feature includes a rail channel.

6. The apparatus of claim 5, wherein the respective rail channel defines a depression in a respective one of the plurality of arms, the depression being adapted to accommodate the respective rail within the depression.

7. The apparatus of claim 1, wherein the respective coupling feature include at least one aperture in a respective one of the plurality of arms, the aperture being adapted to accommodate a coupling securing the respective rail to the respective arm.

8. The apparatus of claim 1, wherein the respective coupling feature include at least one raised feature extending from a respective one of the plurality of arms, the raised feature being adapted to accommodate a coupling securing the respective rail to the respective arm.

9. The apparatus of claim 1, wherein the column includes at least one extension adapted to secure a shaft along which the build plate moves.

10. The apparatus of claim 1, wherein the column includes a vertical channel extending along a surface of the column, the vertical channel being formed to couple to the motion system of the build plate.

11. The apparatus of claim 10, wherein the vertical channel defines a depression in the column, the depression being adapted to accommodate the respective rail within the depression.

12. The apparatus of claim 10, wherein the common plane is perpendicular to a line extending along a length of the vertical channel.

13. The apparatus of claim 1, wherein the column, plurality of arms and plurality of feet are formed of a single material extending continuously through the column, plurality of arms and plurality of feet.

14. A system for printing an object, comprising:
a build plate assembly including a build plate and a motion system configured to move the build plate along a vertical linear path;
a print assembly including a print head and a motion system configured to move the print head through a plane perpendicular to the vertical linear path; and
a support structure including:
a column adapted to couple to the motion system of the build plate assembly;
a plurality of arms extending laterally from an upper portion of the column, each of the plurality of arms having a respective coupling feature aligned in a common plane, the coupling feature being formed to couple to a respective rail of the motion system of the print assembly, the plurality of arms securing the respective rails at a fixed position relative to the motion system of the build plate assembly; and
a plurality of feet extending laterally from a lower portion of the column.

15. The system of claim 14, where in the respective coupling feature includes a rail channel.

16. The system of claim 15, wherein the respective rail channel defines a depression in a respective one of the plurality of arms, the depression being adapted to accommodate the respective rail within the depression.

17. The system of claim 14, wherein the respective coupling feature include at least one aperture in a respective one of the plurality of arms, the aperture being adapted to accommodate a coupling securing the respective rail to the respective arm.

18. The system of claim 14, wherein the respective coupling feature include at least one raised feature extending from a respective one of the plurality of arms, the raised feature being adapted to accommodate a coupling securing the respective rail to the respective arm.

19. The system of claim 14, wherein the column includes at least one extension adapted to secure a shaft along which the build plate moves.

20. The system of claim 14, wherein the column includes a vertical channel extending along a surface of the column, the vertical channel being formed to couple to the motion system of the build plate.
